(19) United States
(12) Patent Application Publication
(10) Pub. No.: US 2018/0084341 A1
(43) Pub. Date: Mar. 22, 2018

(54) AUDIO SIGNAL EMULATION METHOD AND APPARATUS

(71) Applicant: Intel Corporation, Santa Clara, CA (US)

(72) Inventors: Hector Alfonso Cordourier Maruri, Guadalajara (MX); Jesus Adan Cruz Vargas, Zapopan (MX); Paulo Lopez Meyer, Zapopan (MX); Jose Rodrigo Camacho Perez, Guadalajara Jalisco (MX); Julio Cesar Zamora Esquivel, Zapopan (MX); Alejandro Ibarra Von Borstel, Tlajomulco (MX)

(21) Appl. No.: 15/273,449

(22) Filed: Sep. 22, 2016

(51) Int. Cl. H04R 3/00; H04R 17/02; G10L 25/90; G10L 19/06; G10L 15/02

(52) U.S. Cl. CPC H04R 3/00; H04R 17/02; G10L 25/90; H04R 2460/13; G10L 15/02; H04R 2201/023; G10L 19/06

(57) ABSTRACT

Embodiments of the present disclosure provide techniques and configurations for an apparatus for audio signal emulation, based on a vibration signal generated in response to a user's voice. In some embodiments, the apparatus may include at least one sensor disposed on the apparatus to generate a sensor signal indicative of vibration induced by a user's voice in a portion of a user's head. The apparatus may further include a controller coupled with the sensor, to transform the sensor signal into an emulated audio signal, with distortions associated with the vibration in the user's head portion that are manifested in the generated sensor signal, to improve speech recognition based on the generated sensor signal at least partially mitigated. Other embodiments may be described and/or claimed.

### FIELD

Embodiments of the present disclosure generally relate to the fields of speech recognition and wearable devices, and more particularly, to wearable devices also configured to sense vibrations based on user's voice and to transform a vibration signal into an emulated audio signal for speech recognition.

### BACKGROUND

Audio sensors, such as microphones, have been employed to capture user's voice through air propagation for speech recognition. Portable or wearable electronic devices (hereinafter simply, wearable devices), including head wearable devices, continue to increase in popularity, and feature increasingly sophisticated functionality.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a diagram illustrating an example apparatus for transformation of a vibration-indicative signal generated in response to a user's voice into an emulated audio signal, in accordance with some embodiments.

FIG. 2 illustrates an example configuration of the apparatus of FIG. 1, in accordance with some embodiments.

FIG. 3 is a block diagram illustrating some aspects of transformation, by the apparatus of FIG. 1, of a vibration-indicative signal generated in response to a user's voice into an emulated audio signal, in accordance with some embodiments.

FIG. 4 is an example comparative diagram that illustrates some aspects of using the emulated audio signal for speech recognition, in accordance with some embodiments.

FIG. 5 is an example experimental setup for testing an apparatus for transformation of a vibration-indicative signal generated in response to a user's voice into an emulated audio signal, in accordance with some embodiments.

FIG. 6 illustrates the example results of the tests performed as described in reference to the experimental setup of FIG. 5, in accordance with some embodiments.

FIG. 7 is an example process flow diagram for transforming a sensor signal generated by a sensor of an apparatus in response to a user's voice, in accordance with some embodiments.

### DETAILED DESCRIPTION

Embodiments of the present disclosure include techniques and configurations for an apparatus and method for audio signal emulation, based on a vibration signal generated in response to vibration induced by a user's voice in a portion of a user's head. In some embodiments, the apparatus may include at least one sensor disposed on the apparatus to generate a sensor signal indicative of the vibration induced by a user's voice in a portion of a user's head. The apparatus may further include a controller coupled with the sensor, to transform the sensor signal into an emulated audio signal. In embodiments, the apparatus may be a head wearable apparatus, the sensors may be piezoelectric transducers, and the emulated signal may be used for speech recognition.

Signal captured through bone conduction may differ from the signal captured through air propagation by audio sensors, such as microphones. For example, the signal may contain distortions that may be present on the nasal phonemes, or, conversely, omit some features that may be characteristic for a typical audio signal. Such distortions and/or omissions in the vibration-indicative signal, if not corrected, may negatively affect speech recognition based on the signal. Accordingly, in some embodiments, the controller, in transforming the sensor signal into an emulated audio signal may mitigate distortions associated with the vibration in the user's head portion that are manifested in the generated sensor signal, thereby potentially improving speech recognition based on the emulated audio signal.

In the following detailed description, reference is made to the accompanying drawings that form a part hereof, wherein like numerals designate like parts throughout, and in which are shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), (A) or (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

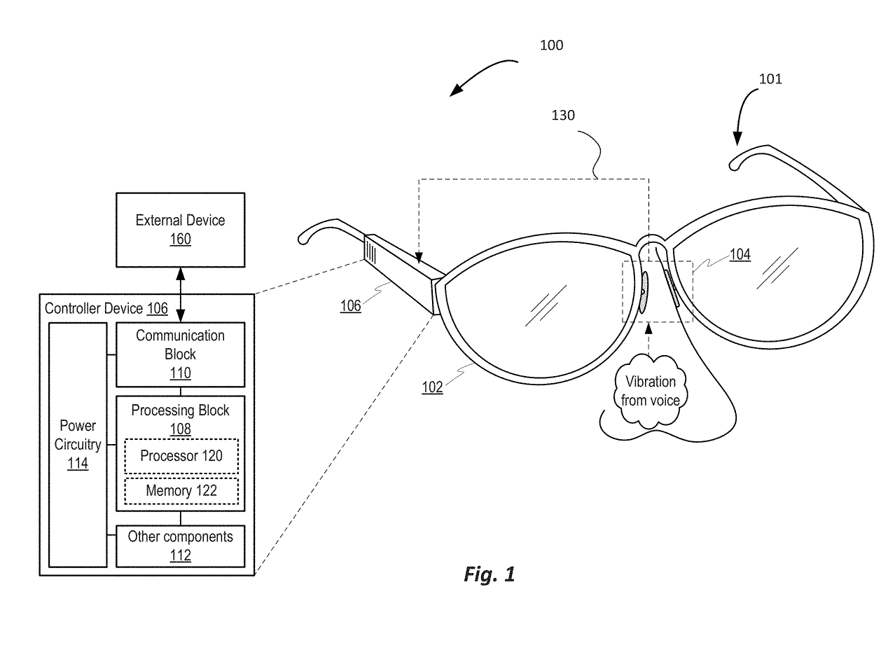

FIG. 1 is a diagram illustrating an example apparatus for transformation of a vibration-indicative signal generated in response to vibration induced by a user's voice in a portion of a user's head into an emulated audio signal, in accordance with some embodiments. The apparatus 100 may comprise a wearable device, to be worn on or around a user's head. The vibration-indicative signal may be provided by vibration sensors disposed in the apparatus 100, in response to vibrations caused by the user's voice in the user's head bones (e.g., nasal bones). This vibration signal, if used in speech recognition or direct voice reproduction, may not always represent the user's voice with desired quality. The apparatus 100 may be configured to transform the vibration-indicative signal into an emulated audio signal, which may be used for reproduction of the user's voice or further processing by a speech recognition system.

Example implementations of the apparatus 100 may include eyeglasses, helmets, headsets, diadems, caps, hats, or other types of headwear. While examples of specific implementations (e.g., in eyeglasses) and/or technologies (e.g., piezoelectric sensors, wireless communications, etc.) may be employed herein, these examples are presented merely to provide a readily comprehensible perspective from which the more generalized devices, methods, etc. described herein may be understood.

As noted above, the apparatus 100 may comprise a wearable device, such as eyeglasses 101, in the example illustrated in FIG. 1. The apparatus 100 may include a frame 102 of eyeglasses 101. The frame 102 is described herein as a part of the apparatus 100 (in this example, eyeglasses 101) for the sake of explanation. Other applications or configurations of an apparatus 100 may result in implementations that remain consistent with the teachings presented herein.

One or more sensors 104 may be disposed on the apparatus 100, such as on the frame 102, as shown in FIG. 1. For ease of explanation, the term “sensor” is used herein to describe at least one sensor, e.g., one, two, or more sensors that may be disposed on the apparatus 100. The sensor 104 may be mounted on the frame 102 via mechanical attachment (e.g., screw, nail or other fastener), adhesive attachment (e.g., a glue, epoxy, etc.) or may be incorporated within the structure of the frame 102. In embodiments, the sensor 104 may comprise vibration sensing circuitry. The sensing circuitry may comprise, for example, piezoelectric components such as a diaphragm or other piezoelectric transducer, to convert vibration (e.g., mechanical pressure waves) occurring in portions of the user's head into signals. In some embodiments, the sensing circuitry may comprise any type of sensors responsive to vibration, such as, for example, microelectromechanical systems (MEMS) accelerometer or the like.

As shown, the sensor 104 may be disposed on the frame 102 to be in contact with, or at least proximate to, the nose of a user wearing the apparatus 100. The bridge of the user's nose may resonate in response to the user's voice. The sensor 104 may be able to detect vibration caused by the nasal bones resonating with the user's voice, and may convert the sensed vibration into a signal 130, e.g., an electronic signal, to be processed as described below.

The embodiments of this disclosure are not limited to nasal vibration detection described above and are described herein for ease of understanding. Other types of vibration indicative of the user's voice may be sensed in different portions of the user's head, such as, for example, temples, forehead, or other portions of the user's head, for example, in the upper portion of the user's head.

The apparatus 100 may further include a controller device 106, which in some embodiments may also be disposed on the apparatus 100 (e.g., the frame 102) as shown. The controller device 106 may be electrically and/or communicatively coupled with the sensor 104, to receive and process the vibration-indicative signal 130 provided by the sensor 104, and to transform the sensor signal into an emulated audio signal, with distortions associated with the vibration in the user's head portion that may be manifested in the generated sensor signal at least partially mitigated. In embodiments, the distortions are substantially mitigated,

The controller device 106 may comprise, for example, a processing block 108, to process the signal 130 and generate an emulated audio signal, and communication block 110 to transmit the signal to an external device 160 for further processing, e.g., using a speech recognition technique. The processing block 108 may comprise at least a processor 120 and memory 122. The processing block 108 may include components configured to record and process the readings of the signal 130. The processing block 108 may provide these components through, for example, a plurality of machine-readable instructions stored in the memory 122 and executable on the processor 120. The controller device 106 may record the signal 130 and store (e.g., buffer) the recorded readings, for example, in the memory 122, for further analysis and processing, e.g., in real time or near-real time.

The processor 120 may include, for example, one or more processors situated in separate components, or alternatively one or more processing cores embodied in a component (e.g., in a System-on-a-Chip (SoC) configuration), and any processor-related support circuitry (e.g., bridging interfaces, etc.). Example processors may include, but are not limited to, various microprocessors including those in the Pentium®, Xeon®, Itanium®, Celeron®, Atom®, Quark®, Core® product families, or the like.

Examples of support circuitry may include host side or input/output (I/O) side chipsets (also known as northbridge and southbridge chipsets/components) to provide an interface through which the processor 120 may interact with other system components that may be operating at different speeds, on different buses, etc. in device 106. Some or all of the functionality commonly associated with the support circuitry may also be included in the same physical package as the processor.

The memory 122 may comprise random access memory (RAM) or read-only memory (ROM) in a fixed or removable format. RAM may include volatile memory configured to hold information during the operation of device 106 such as, for example, static RAM (SRAM) or Dynamic RAM (DRAM). ROM may include non-volatile (NV) memory circuitry configured based on basic input/output system (BIOS), Unified Extensible Firmware Interface (UEFI), etc. to provide instructions when device 106 is activated, programmable memories such as electronic programmable ROMs (erasable programmable read-only memory), Flash, etc. Other fixed/removable memory may include, but is not limited to, electronic memories such as solid state flash memory, removable memory cards or sticks, etc.

The communication block 110 may be communicatively coupled with external device 160 and may include one or more radios capable of transmitting and receiving signals using various suitable wireless communications techniques. Such techniques may involve communications across one or more wireless networks. Some example wireless networks include (but are not limited to) wireless local area networks (WLANs), wireless personal area networks (WPANs), wireless metropolitan area network (WMANs), cellular networks, and satellite networks. In communicating across such networks, the communication block 110 may operate in accordance with one or more applicable standards in any version. To this end, the communication block 110 may include, for instance, hardware, circuits, software, or any combination thereof that allows communication with external computer systems.

In some specific non-limiting examples, the communication block 110 may comport with the Institute of Electrical and Electronics Engineers (IEEE) 802.11 standard (e.g., Wi-Fi), a Bluetooth®, ZigBee®, near-field communication, or any other suitable wireless communication standard. In addition, the communication block 110 may comport with cellular standards such as 3G (e.g., Evolution-Data Optimized (EV-DO), Wideband Code Division Multiple Access (W-CDMA)) and/or 4G wireless standards (e.g., High Speed Packet Access (HSPA), Worldwide Interoperability for Microwave Access (WIMAX), Long-Term Evolution (LTE)).

The apparatus 100 may further include a power circuitry block 114 configured to provide power supply to the components of the controller device 106. In some embodiments, the power circuitry block 114 may be configured to power on the controller device 106 continuously or periodically, in order to save battery power. In some embodiments, the power circuitry block 114 may be configured to power on the controller device 106 on a “wake-up” basis, e.g., in response to vibration detection by the sensor 104. The power circuitry block 114 may include internal power sources (e.g., battery, fuel cell, etc.) and/or external power sources (e.g., power grid, electromechanical or solar generator, external fuel cell, etc.) and related circuitry configured to supply device 106 with the power needed to operate.

The controller device 106 may include other components 112 that may be necessary for functioning of the apparatus 100. Other components 112 may include, for example, hardware and/or software to allow users to interact with the controller device 106 such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in other components 112 may be incorporated within the controller device 106 and/or may be external to the device 106 and coupled to device 106 via a wired or wireless communication medium.

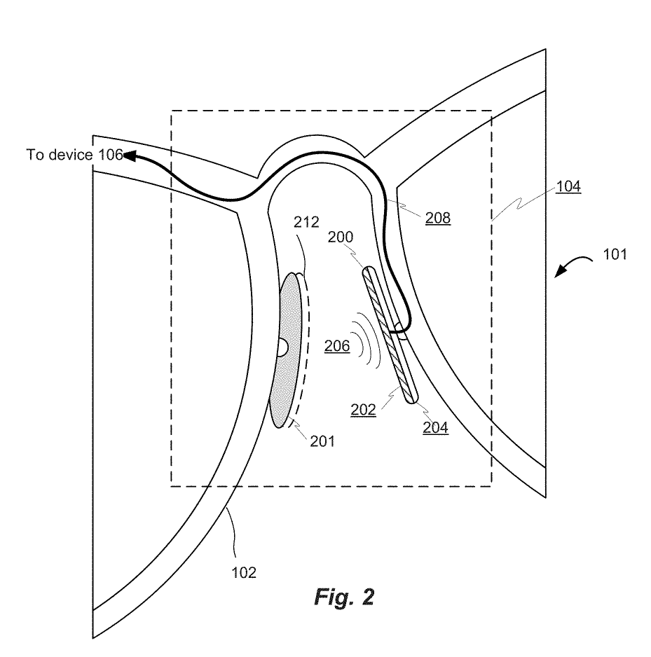

FIG. 2 illustrates an example configuration of the apparatus of FIG. 1, in accordance with some embodiments. More specifically, FIG. 2 illustrates an example disposition of the sensing circuitry in the frame 102 of the apparatus 100. For ease of understanding, like elements of FIGS. 1 and 2 are indicated by like numerals. As shown, the sensor 104 may be disposed within a nosepiece 200 of the frame 102. The sensor 104 may comprise, for example, sensing circuitry (e.g., piezoelectric transducer) 202 affixed or removably attached to structural support 204 of the nosepiece 200 of the frame 102. The sensing circuitry 202 may include, for example, a piezoelectric diaphragm to convert vibration 206 into a signal. Vibration 206 may occur due to the user's nasal bones (not shown) that may resonate in response to the user's voice. The piezoelectric diaphragm comprising the sensing circuitry 202 may be able to accurately generate a signal indicative of the nasal bones' vibration caused by the user's voice and may not require external power, because the pressure waves may compress a piezoelectric crystal of the diaphragm to generate the electronic signal.

The eyeglasses 101 may further include a wire 208 to convey the signal from the sensor 104 to the controller device 106. The wire 208 is shown for illustration purposes; the use of wireless communication may also be possible to transmit the signal to the controller device 106.

A variety of sensor configurations may be implemented consistent with the present disclosure. For example, given that two nosepieces 200 and 201 may exist in a common pair of glasses, at least one of the two nosepieces 200, 201 may include the sensor 104. In another example implementation, both nosepieces 200 and 201 may include sensing circuitries 202 and 212 (shown in dashed lines), comprising the sensor 104. For example, the circuitries 202 and 212 disposed in each nosepiece 200 may be wired in series to generate stronger signals. In another embodiment, the circuitries 202, 212 in the nosepieces 200, 201 may be wired individually, and the controller device 106 (e.g., processing block 108) may select the sensor circuitry 202 or 212 of the sensor 104 to employ based on the strength of the electronic signals received from each sensor circuitry. In this manner, the apparatus 100 may be able to account for the particularities in each user's nasal bones (e.g., breaks, natural deformities such as a deviated septum, etc.) and select the particular sensor circuitry that may provide the strongest and cleanest signal.

In some embodiments, the apparatus may comprise a wearable device other than eyeglasses, for example a hat, a headset, a helmet, or other type of headwear. The vibration sensor (or sensors) may be disposed in different areas of the wearable device, in order to sense vibration of the user's head bones in response to the user's voice. In general, the sensors may be disposed such as to provide a contact (e.g., direct contact or proximity contact) between the sensors and an upper portion of the user's head in response to application of the wearable device to the user's head. For example, the sensors may be disposed in a head-fitting area of a respective wearable device in order to provide the contact between the sensors and the temples or forehead of the user, to conduct sensing of the respective bone vibration in response to the user's voice. In general, any headwear or form factors that may provide for contact of a sensor with an upper portion of the user's head may be used with embodiments described herein.

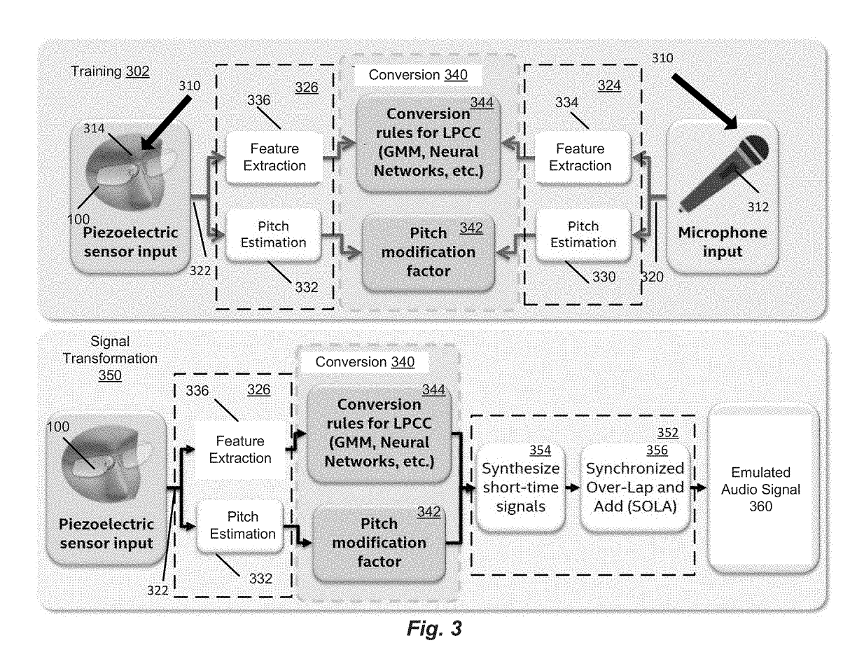

FIG. 3 is a block diagram illustrating some aspects of transformation, by the apparatus of FIG. 1, of a vibration-indicative signal generated in response to a user's voice into an emulated audio signal, in accordance with some embodiments.

As described above, the vibration-indicative signal provided by vibration sensors in response to vibrations caused by the user's voice in the user's head bones may not always represent the user's voice with desired quality. In other words, the vibration signal may not be intelligible enough to be reproduced by a speaker or further processed by a speech recognition system. The described embodiments provide for a transformation of the vibration-indicative signal into an emulated audio signal, which may be used for direct reproduction or further processing by the speech recognition system.

In order to achieve such transformation, a signal training system may be provided as described herein. The signal training system may be configured to correlate features (characteristics) of a vibration signal produced by a vibration sensor in response to a user's voice, to features of an audio signal that may be produced by an audio sensor (e.g., the audio sensor of the training system) in response to the user's voice, if such audio sensor were to be used to sense the user's voice.

The signal training system 302 is shown in FIG. 3. The user's voice 310 (rather, vibration occurring in the air or in the user's head bones in response to user's voice) may be inputted into and sensed by an audio sensor 312 (e.g., microphone). Similarly, a vibration sensor 314 (e.g. piezoelectric transducer of the apparatus 100) may sense vibrations of the user's head bones in response to the user's voice 310. The audio sensor output 320 and vibration sensor output 322 may be provided to respective feature extraction blocks 324 and 326.

The feature extraction blocks 324 and 326 may comprise feature extraction routines configured to extract characteristic features from frequency-based signals. For example, pitch estimation sub-blocks 330 and 332 of the feature extraction blocks 324 and 326 may be routines configured to detect voice characteristics, such as a main frequency of voice (or formant, as it is known by singers). The routines to detect the pitch from an audio output signal 320 or vibration-indicative signal 322 may be based, for example, on a Fast Fourier Transform (FFT), in which the more prominent frequency may be detected on the signal spectrum. A Fourier Transform is a representation of the frequency components (spectrum) of a signal in the frequency domain, as opposed to the temporal domain.

Feature extraction sub-blocks 334 and 336 may be configured to extract signal features pertaining to the sensor signal 322 and to the audio sensor output signal 320. In some embodiments, the features may include linear predictive coding (LPC) cepstrum coefficients or mel-frequency cepstral coefficients (MFCC). LPC is a tool that may be normally used for speech signal compression in a person-to-person voice transformation. However, the LPC features may be used for adaptation of a vibration signal to an audio signal, even though some of the LPC characteristics (for example, changes in rate of speech, or syllables per second) may not be necessary for such application.

Accordingly, at sub-blocks 334 and 336, respective feature (e.g., LPC) models may be generated: the model of the audio output signal 320 (using a voice recording or live input into the audio sensor 312 in low noise conditions), and the model of the vibration (e.g., piezo) signal (using the apparatus 100). The models may be complemented by respective pitch estimation characteristics provided by sub-blocks 330 and 332. Once the features are extracted from the signals 320 and 322, they may be correlated at conversion block 340.

The signal models may be segmented into small time blocks, typical in Fourier analysis. From each time block, the signal features, such as LPC Cepstrum (LPCC) coefficients and the pitch estimation (main frequency formant, or tone) of the audio sensor 312 and the vibration sensor 314 may be used to train a conversion block 340. The conversion block 340 may be trained to obtain the signal features (e.g., LPC features and pitch characteristics) pertaining to the audio sensor signal from the features of the vibration sensor signal. For example, the pitch modification factor sub-block 342 of block 340 may be a routine to turn or convert the pitch from the vibration signal into the pitch pertaining to an audio output signal (e.g., microphone). The sub-block 344 of block 340 may comprise conversion rules for LPCC. Such conversion rules may be implemented, for example, as a Gaussian mixture model (GMM) or a neural network (NN).

Once the conversion block 340 is trained as discussed above, it may be used e.g., by the controller 106 of the apparatus 100 to transform the vibration sensor signal, generated in response to vibration of the user's head bones caused by the user's voice, into an emulated audio signal. In other words, the emulated audio signal may be reconstructed from the calculated vibration signal features (e.g., LPC and/or other features). This emulated audio signal may be provided to a speaker for speech reproduction, or to automatic speech recognition (ASR) engine or any speech-related usage, to improve intelligibility or enhance speech recognition performance.

The signal transformation system 350 configured to transform the vibration sensor signal into an emulated audio signal is shown in FIG. 3. The signal transformation system 350 may be integrated with the controller 106 of the apparatus 100, as discussed above. As shown, the vibration sensor signal 322, generated in response to the user's voice, may be provided to the feature extraction block 326 (described above). At block 326, the signal features may be extracted from the vibration sensor signal 322 as described above.

The extracted features may be provided to conversion block 340 (described above). At block 340, at least some of the features extracted from the vibration sensor signal 320 may be correlated to, and identified as, features of a corresponding audio sensor signal if such sensor sensed the user's voice and provided the audio signal in response. Accordingly, an audio signal may be emulated, e.g., reconstructed from the vibration sensor signal using the identified features.

At signal synthesis block 352, an audio signal may be synthesized from the obtained features (e.g. LPC, pitch estimation and/or other features). This process may be described as the inverse process of obtaining the LPC features and pitch estimation from the audio signal. At sub-block 354, small blocks of the signal (short-time audio signals) may be calculated. At sub-block 356, the calculated signal blocks may be coupled together, using, for example, a synchronized overlap-add (OLA) routine to generate a continuous audio output signal from a signal previously divided in time blocks.

A similar process may be used for synthesizing an emulated audio signal using features other than LPC. The resulting emulated audio signal 360 may be provided for reproduction or further processing (e.g., ASR).

Using an emulated audio signal, generated from a vibration signal, in a speech recognition system may provide a number of advantages for speech recognition performance, if compared with using the non-transformed vibration signal in the speech recognition system.

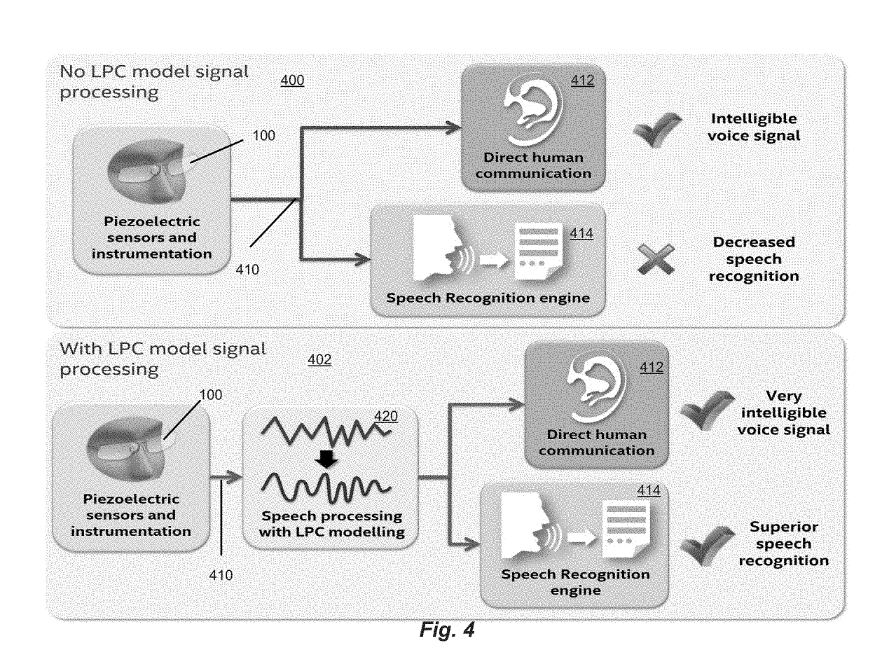

FIG. 4 is an example comparative diagram that illustrates some aspects of using the emulated audio signal for speech recognition, in accordance with some embodiments.

The diagram 400 illustrates the use of the vibration signal provided e.g., by the piezoelectric sensor of the apparatus 100 in response to the user's voice, without signal processing described herein. As shown, the vibration sensor signal 410 generated by the piezoelectric sensor of the apparatus 100 in response to the user's voice may be used directly for voice reproduction for direct human communication (block 412) with somewhat adequate intelligibility. Alternatively, the signal 410 may be provided directly to a speech recognition engine 414. As shown, the resulting recognized speech may be inadequate and not necessarily intelligible.

The diagram 402 illustrates the use of the vibration signal provided by the piezoelectric sensor of the apparatus 100 in response to the user's voice, with signal transformation techniques described herein. Specifically, the signal 410 may be processed by the controller 106 of the apparatus 100 with integrated signal transformation routine described in reference to FIG. 3 and indicated by the block 420. For example, block 420 may include feature extraction block 326, conversion block 340, and signal synthesis block 352, in order to generate an emulated audio signal according to the embodiments described in reference to FIG. 3.

As shown, voice reproduction 412 for direct human communication using the emulated audio signal (e.g., if reproduced via a speaker after synthesis) may provide a desired intelligibility. Similarly, the speech recognition engine 414 may provide superior results using the emulated audio signal, compared to the results described in reference to diagram 400.

The testing of the apparatus for transformation of a vibration-indicative signal generated in response to a user's voice into an emulated audio signal may further illustrate the advantages of using the sensor signal transformation described in reference to FIG. 3.

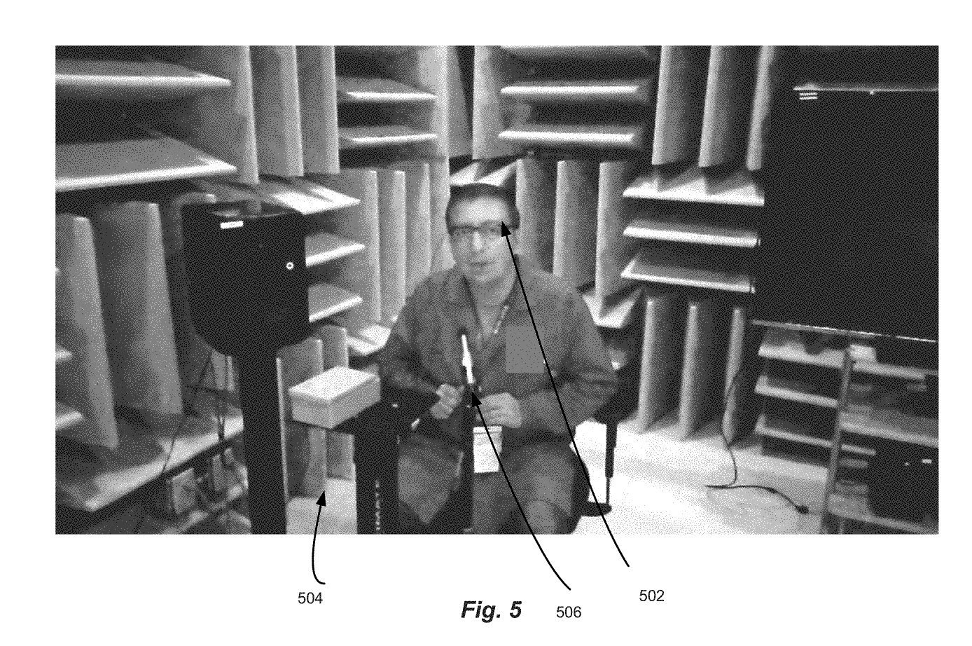

FIG. 5 is an example experimental setup for testing an apparatus for transformation of a vibration-indicative signal generated in response to a user's voice into an emulated audio signal, in accordance with some embodiments. To test the apparatus described herein, two piezoelectric sensors connected in series, each composed of a metallic disk and a thin layer of piezoelectric material (Murata® 7BB-20-6L0) may be placed on the nasal support of a pair of commercially available eyewear glasses.

As shown, the test subject may wear the prototype glasses 502 inside an anechoic chamber 504, with a microphone 506 directed at his mouth. A training recording (e.g., about 30 seconds of random text) may be made in no-noise conditions, to generate the LPC training models. After that, the test subject may utter multiple samples of spoken keywords in a noisy environment (emulating a zero signal to noise ratio).

The signal may be recorded on both sensors at a sample frequency of 44 kHz, and down sampled to 16 kHz for post-processing analysis. The time series signal may be divided into 64 ms of windows with about 75% of time overlap. Each window may be passed through the feature extraction routine. For example, a GMM algorithm may be used for the training routine described in reference to diagram 302 of FIG. 3. The GMM algorithm may produce the LPC features needed to reconstruct the signal for the transformation stage described in reference to diagram 350 of FIG. 3.

The microphone signal, the signal from the piezoelectric sensors, and the signal from the piezoelectric sensors processed using the signal transformation routine described in reference to 350 of FIG. 3, may be fed into the ASR engine, using a keyword set (e.g., ten keywords).

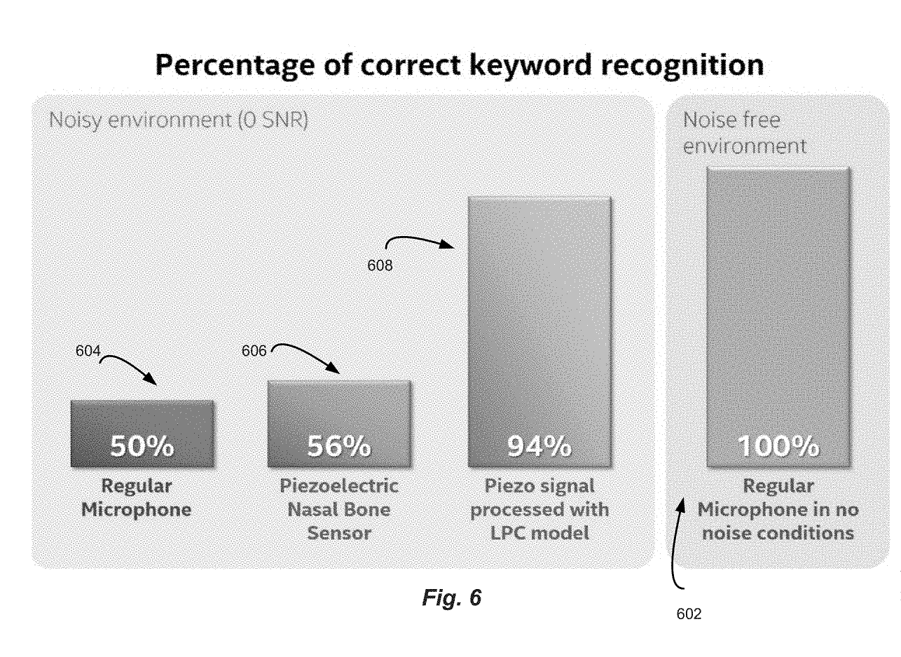

FIG. 6 illustrates the example results of the tests performed as described in reference to the experimental setup of FIG. 5, in accordance with some embodiments.

As noted above, the keyword recognition rate that indicates speech recognition performance may be measured with an ASR engine, e.g., Siri® or Cortana®. The best performance result of the ASR engine (e.g., 100% keyword recognition) may be achieved using a signal provided by a regular microphone in a noise free location, such as the anechoic chamber 504 of FIG. 5, as an input into the ASR. The ASR performance results (about 100% recognition rate) are shown in graph 602.

In a high ambient noise environment, in which the signal to noise ratio (SNR) may be reduced to zero dB, the performance of an ASR engine may be described as follows. If a regular microphone signal is used as in input, recognition performance of the ASR engine may decrease to about 50%, as shown in graph 604.

If a vibration signal provided by piezoelectric sensors (e.g., embedded in eyeglasses of FIGS. 1, 2, and 5) is used by the ASR without application of a signal transformation routine described in reference to FIG. 3, the performance of the ASR engine may reach about 56%, as shown in graph 606.

If the vibration signal is transformed into an emulated audio signal using the signal transformation routine with vibrations substantially mitigated, before provision to the ASR engine, the ASR engine performance may increase up to 94%, as shown in graph 608.

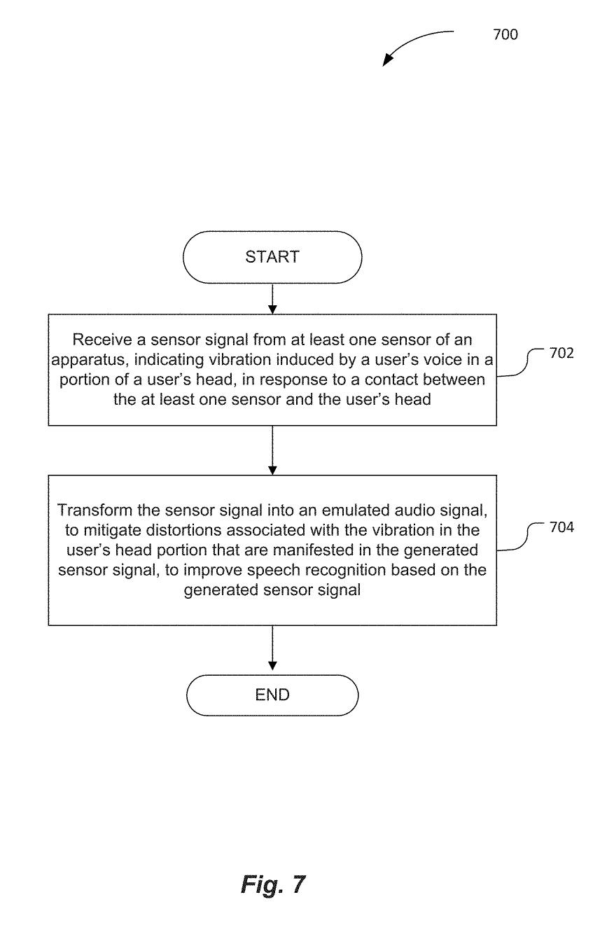

FIG. 7 is an example process flow diagram for transforming a sensor signal generated by a sensor of an apparatus in response to a user's voice, in accordance with some embodiments. The process 700 may comport with some of the apparatus embodiments described in reference to FIGS. 1-5. For example, the apparatus may comprise the apparatus (wearable device) 100 of FIG. 1, and the process 700 may be performed by the controller 106 of the apparatus 100. In alternate embodiments, the process 700 may be practiced with more or fewer operations, or a different order of the operations.

The process 700 may begin at block 702 and include receiving a sensor signal from at least one sensor of the apparatus. The sensor signal may indicate vibration induced by a user's voice in a portion of a user's head. The sensor may be the vibration sensor 104, such as a piezoelectric sensor.

At block 704, the process 700 may include transforming the sensor signal into an emulated audio signal that emulates audio signal collected through air propagation. The transformation may reduce or remove distortions associated with the vibration in the user's head portion that are manifested in the generated sensor signal. The emulated audio signal may be used for speech recognition. Transforming the sensor signal into an emulated audio signal may include reconstructing an audio sensor output signal generated by an audio sensor of a system to train the controller to transform the sensor signal into the emulated audio signal, based at least in part on the generated sensor signal, if the audio sensor is to sense the user's voice. More specifically, transforming the sensor signal may include extracting features pertaining to the audio sensor output signal from the sensor signal, and generating the emulated audio signal, based at least in part on the extracted features.

The following paragraphs describe examples of various embodiments.

Example 1 may be an apparatus for audio signal emulation, comprising: at least one sensor disposed on the apparatus to generate a sensor signal indicative of vibration induced by a user's voice in a portion of a user's head; and a controller coupled with the at least one sensor, to transform the sensor signal into an emulated audio signal, with distortions associated with the vibration in the user's head portion that are manifested in the generated sensor signal at least partially mitigated.

Example 2 may include the apparatus of Example 1, wherein the apparatus further comprises a head-fitting component to be mounted at least partly around the user's head, wherein the head-fitting component is to provide contact between the sensor and the portion of the user's head, in response to application of the apparatus to the user's head, wherein the apparatus comprises a wearable device.

Example 3 may include the apparatus of Example 1, wherein the at least one sensor comprises a piezoelectric transducer responsive to vibration.

Example 4 may include the apparatus of Example 1, wherein to transform the sensor signal into an emulated audio signal includes to reconstruct an audio sensor output signal generated by an audio sensor of a system to train the controller to transform the sensor signal into the emulated audio signal, based at least in part on the generated sensor signal.

Example 5 may include the apparatus of Example 4, wherein to transform the sensor signal into an emulated audio signal further includes to: extract features pertaining to the audio sensor output signal from the sensor signal; and generate the emulated audio signal, based at least in part on the extracted features.

Example 6 may include the apparatus of Example 5, wherein the features include one or more of: linear predictive coding (LPC) coefficients, mel-frequency cepstral coefficients (MFCC), or voice pitch estimation frequency characteristics.

Example 7 may include the apparatus of Example 5, wherein to generate the emulated audio signal based at least in part on the extracted features includes to: synthesize the emulated audio signal from the extracted features.

Example 8 may include the apparatus of Example 7, wherein to generate the emulated audio signal further includes to correlate the extracted features to corresponding characteristics indicative of the audio sensor output signal, to emulate the audio sensor output signal.

Example 9 may include the apparatus of Example 1, wherein the controller includes a processing block to transform the sensor signal into the emulated audio signal, and a communication block to transmit the emulated audio signal to an external device.

Example 10 may include the apparatus of Example 1, wherein the apparatus comprises eyeglasses, wherein the head-fitting component comprises a frame, wherein the portion of the user's head comprises one of: a nose, a temple, or a forehead, wherein the sensor is mounted or removably attached on a side of the frame that is placed adjacent to the nose, temple, or forehead respectively, in response to application of the eyeglasses to the user's head.

Example 11 may include the apparatus of Example 1, wherein the apparatus comprises one of: a helmet, a headset, a patch, or other type of headwear, wherein the head-fitting component comprises a portion of the apparatus to provide a contact between the at least one sensor and an area of the portion of the user's head, wherein the portion of the user's head comprises one of: a nose, a temple, or a forehead.

Example 12 may be a method for audio signal emulation, comprising: receiving, by a controller coupled with an apparatus placed on a user's head, a sensor signal from at least one sensor of the apparatus, the sensor signal indicating vibration induced by a user's voice in a portion of the user's head; and transforming, by the controller, the sensor signal into an emulated audio signal, with distortions associated with the vibration in the user's head portion that are manifested in the generated sensor signal, to improve speech recognition based on the generated sensor signal at least partially mitigated.

Example 13 may include the method of Example 12, wherein transforming the sensor signal into an emulated audio signal includes reconstructing, by the controller, an audio sensor output signal generated by an audio sensor of a system to train the controller to transform the sensor signal into the emulated audio signal, based at least in part on the generated sensor signal, if the audio sensor is to sense the user's voice.

Example 14 may include the method of Example 13, wherein transforming the sensor signal into an emulated audio signal further includes: extracting, by the controller, features pertaining to the audio sensor output signal from the sensor signal; and generating, by the controller, the emulated audio signal, based at least in part on the extracted features.

Example 15 may include the method of Example 14, wherein generating the emulated audio signal includes synthesizing, by the controller, the emulated audio signal from the extracted features.

Example 16 may include the method of Example 15, wherein generating the emulated audio signal further includes correlating, by the controller, the extracted features to corresponding characteristics indicative of the audio sensor output signal, to emulate the audio sensor output signal.

Example 17 may be one or more non-transitory controller-readable media having instructions for audio signal emulation stored thereon that, in response to execution on a controller of an apparatus placed on a user's head, cause the controller to: receive a sensor signal from at least one sensor of the apparatus, wherein the sensor signal indicates vibration induced by a user's voice in a portion of the user's head; and transform the sensor signal into an emulated audio signal, with distortions associated with the vibration in the user's head portion that are manifested in the generated sensor signal, to improve speech recognition based on the generated sensor signal at least partially mitigated.

Example 18 may include the non-transitory controller-readable media of Example 17, wherein the instructions that cause the controller to transform the sensor signal into an emulated audio signal further cause the controller to reconstruct an audio sensor output signal generated by an audio sensor of a system to train the controller to transform the sensor signal into the emulated audio signal, based at least in part on the generated sensor signal, if the audio sensor is to sense the user's voice.

Example 19 may include the non-transitory controller-readable media of Example 18, wherein the instructions that cause the controller to transform the sensor signal into an emulated audio signal further cause the controller to: extract features pertaining to the audio sensor output signal from the sensor signal; and generate the emulated audio signal, based at least in part on the extracted features.

Example 20 may include the non-transitory controller-readable media of Example 19, wherein the instructions that cause the controller to generate the emulated audio signal further cause the controller to: correlate the extracted features to corresponding characteristics indicative of the audio sensor output signal, to emulate the audio sensor output signal; and synthesize the emulated audio signal, based at least in part on a result of the correlation.

Example 21 may be an apparatus for audio signal emulation, comprising: means for receiving a sensor signal from at least one sensor of the apparatus, the sensor signal indicating vibration induced by a user's voice in a portion of the user's head; and means for transforming the sensor signal into an emulated audio signal, with distortions associated with the vibration in the user's head portion that are manifested in the generated sensor signal, to improve speech recognition based on the generated sensor signal at least partially mitigated.

Example 22 may include the apparatus of Example 21, wherein means for transforming the sensor signal into an emulated audio signal includes means for reconstructing an audio sensor output signal generated by an audio sensor of a system to train the controller to transform the sensor signal into the emulated audio signal, based at least in part on the generated sensor signal, if the audio sensor is to sense the user's voice.

Example 23 may include the apparatus of Example 22, wherein means for transforming the sensor signal into an emulated audio signal further includes: means for extracting features pertaining to the audio sensor output signal from the sensor signal; and means for generating the emulated audio signal, based at least in part on the extracted features.

Example 24 may include the apparatus of Example 23, wherein means for generating the emulated audio signal includes means for synthesizing the emulated audio signal from the extracted features.

Example 25 may include the apparatus of Example 24, wherein means for generating the emulated audio signal further includes means for correlating the extracted features to corresponding characteristics indicative of the audio sensor output signal, to emulate the audio sensor output signal.

Various operations are described as multiple discrete operations in turn, in a manner that is most helpful in understanding the claimed subject matter. However, the order of description should not be construed as to imply that these operations are necessarily order dependent. Embodiments of the present disclosure may be implemented into a system using any suitable hardware and/or software to configure as desired.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

1. An apparatus, comprising:
at least one sensor disposed on the apparatus to generate sensor signals indicative of vibration induced by a user's voice in a portion of the user's head; and
a controller coupled with the at least one sensor, wherein the controller is trained to transform the sensor signals into emulated audio signals, which includes having been trained to correlate one or more features indicative of audio sensor output signals that are generated in response to the user's voice, with respective one or more features indicative of the sensor signals,
wherein the controller, in response to a receipt of a first of the sensor signals, transforms the first sensor signal into a first emulated audio signal by a derivation of one or more features pertaining to a first audio sensor output signal responsive to the user's voice, from one or more features indicative of the first sensor signal, without using the first audio sensor output signal.

2. The apparatus of claim 1, wherein the apparatus further comprises a head-fitting component to be mounted at least partly around the user's head, wherein the head-fitting component is to provide contact between the sensor and the portion of the user's head, in response to application of the apparatus to the user's head, wherein the apparatus comprises a wearable device.

3. The apparatus of claim 1, wherein the at least one sensor comprises a piezoelectric transducer responsive to vibration.

4. The apparatus of claim 1, wherein the controller is trained to obtain an ability to derive the one or more features pertaining to the first audio sensor output signal from the one or more features indicative of the first sensor signal.

5. The apparatus of claim 1, wherein to transform the first sensor signal into the first emulated audio signal further includes to:
extract the one or more features pertaining to the first audio sensor output signal from the first sensor signal; and
generate the first emulated audio signal, based at least in part on the extracted features.

6. The apparatus of claim 5, wherein the features include one or more of: linear predictive coding (LPC) coefficients, mel-frequency cepstral coefficients (MFCC), or voice pitch estimation frequency characteristics.

7. The apparatus of claim 5, wherein to generate the first emulated audio signal based at least in part on the extracted features includes to: synthesize the first emulated audio signal from the extracted features.

8. (canceled)

9. The apparatus of claim 1, wherein the controller includes a processing block to transform the sensor signal into the emulated audio signal, and a communication block to transmit the emulated audio signal to an external device.

10. The apparatus of claim 1, wherein the apparatus comprises eyeglasses, wherein the head-fitting component comprises a frame, wherein the portion of the user's head comprises one of: a nose, a temple, or a forehead, wherein the sensor is mounted or removably attached on a side of the frame that is placed adjacent to the nose, temple, or forehead respectively, in response to application of the eyeglasses to the user's head.

11. The apparatus of claim 1, wherein the apparatus comprises one of: a helmet, a headset, a patch, or other type of headwear, wherein the head-fitting component comprises a portion of the apparatus to provide a contact between the at least one sensor and an area of the portion of the user's head, wherein the portion of the user's head comprises one of: a nose, a temple, or a forehead.

12. A method, comprising:
receiving, by a controller coupled with an apparatus placed on a user's head, a first of sensor signals from at least one sensor of the apparatus, the sensor signals indicating vibration induced by a user's voice in a portion of the user's head, wherein the controller is trained to transform the sensor signals into emulated audio signals, including to correlate one or more features indicative of audio sensor output signals that are generated in response to the user's voice, with respective one or more features indicative of the sensor signals; and
transforming, by the controller, the first the sensor signal into a first emulated audio signal, wherein the transforming includes:
deriving, by the controller, one or more features pertaining to a first audio sensor output signal responsive to the user's voice, from one or more features indicative of the first sensor signal, without using the first audio sensor output signal; and
providing, by the controller, the first emulated audio signal, based at least in part on a result of the deriving.

13. The method of claim 12, further comprising: prior to a transformation of the first sensor signal into the first emulated audio signal, obtaining, by the controller, an ability to derive the one or more features pertaining to the first audio sensor output signal from the one or more features indicative of the first sensor signal.

14. The method of claim 12, wherein transforming the first sensor signal into the first emulated audio signal further includes:
extracting, by the controller, the one or more features pertaining to the first audio sensor output signal from the first sensor signal; and
generating, by the controller, the first emulated audio signal, based at least in part on the extracted features.

15. The method of claim 14, wherein generating the first emulated audio signal includes synthesizing, by the controller, the first emulated audio signal from the extracted features.

16. (canceled)

17. One or more non-transitory controller-readable media having instructions stored thereon that, in response to execution on a controller of an apparatus placed on a user's head, cause the controller to:
receive a first of sensor signals from at least one sensor of the apparatus, wherein the sensor signals indicates vibration induced by a user's voice in a portion of the user's head, wherein the controller is trained to transform the sensor signals into emulated audio signals, which includes to correlate one or more features indicative of audio sensor output signals that are generated in response to the user's voice, with respective one or more features indicative of the sensor signals; and
transform the first sensor signal into a first emulated audio signal, wherein to transform includes to derive one or more features pertaining to a first audio sensor output signal responsive to the user's voice, from one or more features indicative of the first sensor signal, without using the first audio sensor output signal, to provide the first emulated audio signal.

18. (canceled)

19. The non-transitory controller-readable media of claim 17, wherein
the instructions that cause the controller to transform the first sensor signal into the first emulated audio signal further cause the controller to:
extract the one or more features pertaining to the first audio sensor output signal from the first sensor signal; and
generate the first emulated audio signal, based at least in part on the extracted features.

20. The non-transitory controller-readable media of claim 19, wherein the instructions that cause the controller to generate the first emulated audio signal further cause the controller to synthesize the first emulated audio signal, from the extracted features.
